(19) United States
(12) Patent Application Publication
(10) Pub. No.: US 2019/0363816 A1
(43) Pub. Date: Nov. 28, 2019

(54) DEVICE AND SYSTEM

(71) Applicants: QUADRAC Co., Ltd., Tokyo (JP); DENSO CORPORATION, Aichi (JP)

(72) Inventors: Susumu Kusakabe, Tokyo (JP); Fumio Kubono, Tokyo (JP); Akihiko Yamagata, Tokyo (JP); Munenori Matsumoto, Aichi (JP); Kazunari Nakamura, Aichi (JP); Taichi Yamaguchi, Aichi (JP)

(73) Assignees: QUADRAC Co., Ltd., Tokyo (JP); DENSO CORPORATION, Aichi (JP)

(21) Appl. No.: 16/485,682

(22) PCT Filed: Feb. 14, 2017
(86) PCT No.: PCT/JP2017/005371

§ 371 Date: Aug. 13, 2019

(51) Int. Cl. H04J 3/06

(52) U.S. Cl. CPC H04J 3/0682; H04J 3/0697

(57) ABSTRACT

[Problem] A distance between one device and another device can be calculated without taking delay time on the other device into consideration by calculating an average value of propagation time between the two devices through bidirectional communication performed therebetween.

[Solution] A device including: a transmission unit configured to send a first signal to another device; a reception unit configured to receive, from the other device, a first signal reception time measured by a clock unit provided on the other device, a second signal, a second signal transmission time measured by the clock unit provided on the other device; a clock unit in the above-mentioned device, the clock unit being configured to operate not in synchronism with the clock unit provided on the other device and measure a first signal transmission time and a second signal reception time; and a calculation unit configured to calculate average propagation time between the above-mentioned device and the other device on the basis of the first signal transmission time measured by the clock unit in the above-mentioned device, the first signal reception time received by the reception unit, the second signal transmission time received by the reception unit, and the second signal reception time measured by the clock unit in the above-mentioned device and calculate a distance between the above-mentioned device and the other device on the basis of the calculated average propagation time and a propagation speed.

### TECHNICAL FIELD

The present invention relates to distance measurement.

### BACKGROUND ART

A system for performing distance measurement by using a procedure for packet transmission and reception between a sender and a recipient has been proposed (see PTL 1).

### CITATION LIST

### Patent Literature

### [PTL 1] Japanese Patent Application Publication No. 2004-258009

### SUMMARY OF INVENTION

### Technical Problem

However, in the above system, since delay time on the recipient side (time taken between receiving a packet and returning a packet) needs to be taken into consideration, the distance between the sender and the recipient could not accurately be calculated.

### Solution to Problem

For example, the above problem can be solved by the following means.

A device including: a transmission unit configured to send a first signal to another device; a reception unit configured to receive, from the other device, a first signal reception time measured by a clock unit provided on the other device, a second signal, a second signal transmission time measured by the clock unit provided on the other device; a clock unit in the above-mentioned device, the clock unit being configured to operate not in synchronism with the clock unit provided on the other device and measure a first signal transmission time and a second signal reception time; and a calculation unit configured to calculate average propagation time between the above-mentioned device and the other device on the basis of the first signal transmission time measured by the clock unit in the above-mentioned device, the first signal reception time received by the reception unit, the second signal transmission time received by the reception unit, and the second signal reception time measured by the clock unit in the above-mentioned device and calculate a distance between the above-mentioned device and the other device on the basis of the calculated average propagation time and a propagation speed.

A system including: the above-mentioned device; and the other device described above.

### Advantageous Effects of Invention

A distance between one device and another device can be calculated without taking delay time on the other device into consideration by calculating an average value of propagation time between the two devices through bidirectional communication performed therebetween.

### BRIEF DESCRIPTION OF DRAWINGS

FIG. 1 schematically illustrates a configuration of a system 1 according to embodiment 1.

FIG. 2 is a sequence diagram illustrating an example of an operation of the system 1 according to embodiment 1.

### DESCRIPTION OF EMBODIMENTS

[System 1 According to Embodiment 1]

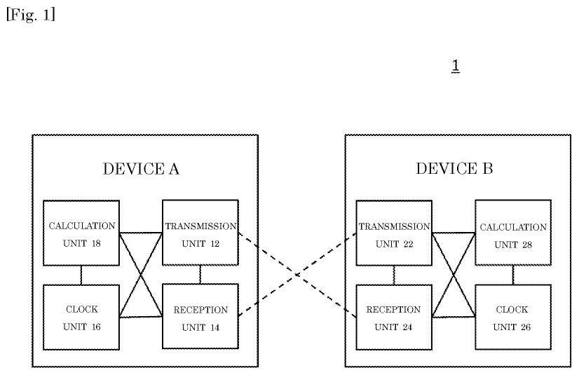

FIG. 1 schematically illustrates a configuration of a system 1 according to embodiment 1. As illustrated in FIG. 1, the system 1 according to embodiment 1 has devices A and B. The devices A and B are provided with transmission units 12 and 22, reception units 14 and 24, clock units 16 and 26, and calculation units 18 and 28, respectively. The devices and units are described in detail herein below.

(Devices A and B)

Each of the devices A and B may be a mobile device carried and used as it is or a device used by being attached to, for example, a smartphone, a key chain, clothes, a belt, a life jacket, a vehicle, a smart key of a vehicle, and a device to send information about the whereabouts of a child. Each of the devices A and B may include a power supply therein. Alternatively, each of the devices A and B may receive a power supply from a different device to which the device is attached or in which the device is included, without including a power supply therein.

(Transmission Units 12 and 22)

Each of the transmission units 12 and 22 sends a signal to another device. Each of the transmission units 12 and 22 can be configured by an antenna, a modulator, or the like.

(Reception Units 14 and 24)

Each of the reception units 14 and 24 receives a signal from another device. Each of the reception units 14 and 24 can be configured by an antenna, a modulator, or the like.

In the present description, the term “another device” means a device other than the above-mentioned device. The device B is another device for the device A, and the device A is another device for the device B. The transmission unit 12 in the device A sends a first signal to the reception unit 24 in the device B. The transmission unit 22 in the device B sends a second signal to the reception unit 14 in the device A. While, for example, packets can constitute the first signal and the second signal, the format of the first signal and the second signal is not particularly limited. Devices having the same configuration and functions can be used as the device A and the device B.

(Clock Units 16 and 26)

Each of the clock units 16 and 26 measures a transmission time and a reception time of the various signals. Namely, the clock unit 16 in the device A measures a first signal transmission time and a second signal reception time, and the clock unit 26 in the device B measures a first signal reception time and a second signal transmission time. The transmission time represents, for example, a time at which the transmission of a signal is started. If a packet constitutes the signal, the transmission time represents a time at which a bit arranged at the beginning of the packet is sent, for example. The reception time represents, for example, a time at which the reception of a signal is started. If a packet constitutes the signal, the reception time represents a time at which a bit arranged at the beginning of the packet is received, for example.

Each of the clock units 16 and 26 can perform measurements of various times by using a reference time and the amount of time elapsed from the reference time. For example, when the reference time of the device A is TA and the amount of time elapsed from the reference time TA to a time at which the first signal is sent is TA1, the clock unit 16 in the device A can measure a first signal transmission time on the basis of a relational expression, which is the first signal transmission time=TA+TA1.

The clock units 16 and 26 in the devices A and B operate not in synchronism with each other. In addition, the clock unit 16 in the device A and the clock unit 26 in device B separately set the respective reference times. The reference times applied by the devices A and B are not necessarily set to an identical time. As will be described below, according to the present embodiment, since the average propagation time can be calculated without using the value of the reference time, the average propagation time between the devices A and B can be calculated irrespective of whether the reference times of the devices A and B are set to an identical time.

The timing to which the clock unit in the individual device sets the reference time is not limited. For example, the individual device may set the reference time to timing at which the power supply is turned on, at which a predetermined button is pressed, etc., and the measurement of a lapse time is started from such timing. According to the present embodiment, since the average propagation time can be calculated without using the value of the reference time, the average propagation time between the devices A and B can be calculated irrespective of the timing to which the clock unit in the individual device sets the reference time.

The value that is used by the clock unit in the individual device as the reference time is not particularly limited. For example, while the clock unit in the individual device can set the reference time to 00h00m00s, it is also possible to set the reference time to values such as 03h03m03s, 12h00m00s, etc. As will be described below, according to the present embodiment, since the average propagation time can be calculated without using the value of the reference time, the average propagation time between the devices A and B can be calculated irrespective of the value that is used by the clock unit in the individual device as the reference time.

The precision with which the clock unit in the individual device stores and measures the reference time and the lapse time is not particularly limited. For example, the clock unit in the individual device can store and measure the reference time and the lapse time in a unit such as s, ms, μs, ns, and ps. However, it is preferable that the clock units in the individual devices use the same precision and unit for storing and measuring the reference time and the lapse time. If the devices A and B use the same precision and unit, the average propagation time between the devices A and B can be calculated with great precision.

The clock units 16 and 26 are not particularly limited as long as the clock units are devices that are capable of setting the reference time, measuring the lapse time from the reference time, and calculating the transmission time and the reception time of the various signals by using the measured lapse time. With respect to the clock units 16 and 26, depending on the precision of the measurement needed, a ceramic oscillator, a crystal oscillator, a temperature-compensated crystal oscillator (TCXO), or the like can suitably be used as each of the clock units 16 and 26.

The first signal reception time and the second signal transmission time measured by the clock unit 16 in the device B are sent from the transmission unit 12 in the device B to the reception unit 24 in the device A.

(Calculation Units 18 and 28)

Each of the calculation units 18 and 28 calculates a distance between the above-mentioned device and the other device. For example, a CPU can be used as each of the calculation units 18 and 28.

On the basis of the first signal transmission time measured by the clock unit 16 in the device A, the first signal reception time received by the reception unit 14 in the device A, the second signal transmission time received by the reception unit 14 in the device A, and the second signal reception time measured by the clock unit 16 in the device A, the calculation unit 18 in the device A calculates the average propagation time between the devices A and B. For example, the propagation time means the time between when one device starts a transmission of one signal and when another device starts a reception of the one signal.

The calculation unit 18 in the devices A and B calculates a distance between the devices A and B on the basis of the average propagation time calculated and a propagation speed (e.g., light speed, sonic speed). The propagation speed is a speed at which the signals propagate. As the propagation speed, for example, if the signal is an electromagnetic wave, the light speed is used, and if the signal is a sonic wave, the sonic speed is used.

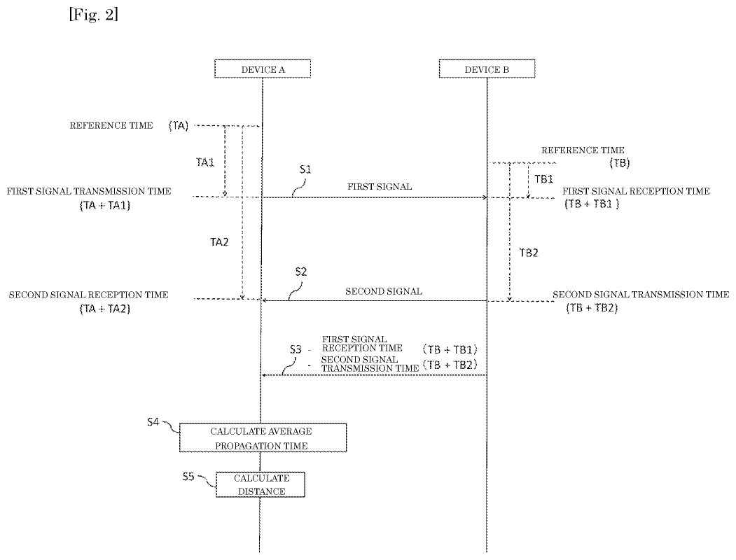

FIG. 2 is a sequence diagram illustrating an example of an operation of the system 1 according to embodiment 1. Hereinafter, an example of an operation of the system 1 according to embodiment 1 will be described with reference to FIG. 2.

(Step S1)

First, the device A sends a first signal to the device B, and the device B receives the first signal from the device A. The device A causes the clock unit 16 therein to measure a first signal transmission time (TA+TA1). The device B causes the clock unit 26 therein to measure a first signal reception time (TB+TB1). TA is the reference time of the device A, and TB is the reference time of the device B. TA1 is the amount of time elapsed from the reference time TA to a time at which the first signal is sent, and TB1 is the amount of time elapsed from the reference time TB to a time at which the first signal is received.

(Step S2)

Next, the device B sends a second signal to the device A, and the device A receives the second signal from the device B. The device B causes the clock unit 26 therein to measure a second signal transmission time (TB+TB2). The device A causes the clock unit 16 therein to measure a second signal reception time (TA+TA2). TA2 is the amount of time elapsed from the reference time TA to a time at which the second signal is received, and TB2 is the amount of time elapsed from the reference time TB to a time at which the second signal is sent.

(Step S3)

Next, the device B sends the first signal reception time (TB+TB1) and the second signal transmission time (TB+TB2), which are measured by the clock unit 26 in the device B, to the device A.

(Step S4)

Next, the device A calculates average propagation time Td0 between the device A and the device B. For example, the average propagation time Td0 can be calculated in accordance with the following expression 1. As illustrated in Expression 1, according to the present embodiment, the average propagation time can be calculated without using the value of the reference time. Thus, the devices A and B can set desired timings as the respective reference times, and the lapse time can separately be measured from the respective timings (reference times).

$$\begin{matrix}Td 1 = ( TB + TB 1 ) - ( TA + TA 1 ) \\ Td 2 = ( TA + TA 2 ) - ( TB + TB 2 ) & [ Math . 1 ] \\ \begin{matrix}Td 0 = ( Td 1 + Td 2 ) / 2 \\ = \{ ( TB + TB 1 ) - ( TA + TA 1 ) + ( TA + TA 2 ) - ( TB + TB 2 ) \} / 2 \\ = ( TB 1 - TA 1 + TA 2 - TB 2 ) / 2\end{matrix} & \end{matrix}$$

(Step S5)

Next, the device A calculates a distance D between the device A and the device B. For example, this distance D can be calculated in accordance with the following expression 2.

D=Td0*V [Math. 2]

V is a propagation speed.

As describe above, according to the present embodiment, since the propagation time Td0 between one device A and another device B is calculated through bidirectional communication between the two devices, the device A can calculate the distance D between the two devices without taking delay time on the other device B into consideration. In addition, according to the present embodiment, the average propagation time can be calculated without using the value of the reference time. Thus, the devices A and B can set desired timings as the respective reference times, and the lapse time can separately be measured from the respective timings (reference times). According to the present embodiment, even in the case where the devices A and B operate asynchronously as described above, the propagation time Td0 between the two devices is calculated, and the distance D therebetween can be calculated.

The device A can send the first signal transmission time (TA+TA1) and the second signal reception time (TA+TA2) calculated by the clock unit 16 in the device A to the device B. In this way, the distance D between the two devices can also be calculated by the device B in accordance with the above expressions 1 and 2.

While the system 1 in the present embodiment is provided with the two devices, which are the device A and the device B, the system 1 can be provided with three or more devices, each of which has a configuration and functions similar to those of the device A. For example, if the system 1 is provided with three devices including the device A, the device B, and a device C, the system 1 can measure a distance between the device A and the device B, a distance between the device A and the device C, and a distance between the device B and the device C.

If the system 1 is provided with a plurality of devices, each of which has a configuration and functions similar to those of the device A, a distance between two objects of various kinds can be measured by attaching these devices to various objects in the world or incorporating the functions of these devices in various objects in the world. Namely, according to the present embodiment, the individual devices such as the device A and the device B can set desired timings as the respective reference times, and the lapse time can separately be measured from the respective timings (reference times). According to the present embodiment, even in the case where the individual devices such as the device A and the device B operate asynchronously, the propagation time between the two devices is calculated, and the distance therebetween can be calculated. Thus, according to the present embodiment, if various persons attach the devices such as the device A and the device B to or incorporate the functions of these devices in various kinds of objects owned or managed by the respective persons, the distance between the two objects of various kinds can be measured without performing reference time synchronization processing, etc. between the devices in advance.

According to the system 1 described above, the distance between two objects of various kinds can be measured. Thus, for example, by measuring the distance between a lost child, a missing person, or a person in distress and a searcher, the person being searched for can easily be found. In addition, by measuring the distance between a wallet, a pair of eyeglasses, etc. and an owner of these objects, the lost article can easily be found. In addition, by measuring the distance between a vehicle and a person, a driver can detect a person jumping out of shadows in advance while driving. In addition, by measuring the distance between a vehicle and another vehicle, the inter-vehicle distance, traffic congestion information, etc. can be obtained. In addition, by measuring the distance between a vehicle and a road shoulder or a center divider, even if the road shoulder and the center divider are buried in slow, the positions of the road shoulder and the center divider can be grasped. In addition, by measuring the distance between an automatically-operated vehicle and a driver outside the vehicle (a smart key), a collision between the automatically-operated vehicle and the driver can be prevented.

While the embodiment has thus been described, the configuration described in the scope of claims is not limited to the description of the embodiment.

### REFERENCE SIGNS LIST

1 System
12, 22 Transmission unit
14, 24 Reception unit
16, 26 Clock unit
18, 28 Calculation unit

1. A device, comprising:
a transmission unit configured to send a first signal to another device;
a reception unit configured to receive, from the other device, a first signal reception time measured by a clock unit provided on the other device, a second signal, a second signal transmission time measured by the clock unit provided on the other device;
a clock unit in said device, the clock unit being configured to operate not in synchronism with the clock unit provided on the other device and measure a first signal transmission time and a second signal reception time; and
a calculation unit configured to calculate average propagation time between said device and the other device on the basis of the first signal transmission time measured by the clock unit in said device, the first signal reception time received by the reception unit, the second signal transmission time received by the reception unit, and the second signal reception time measured by the clock unit in said device and calculate a distance between said device and the other device on the basis of the calculated average propagation time and a propagation speed.

2. A system, comprising:
said device and the other device according to claim 1.
